(19) United States
(12) Patent Application Publication
(10) Pub. No.: US 2008/0186933 A1
(43) Pub. Date: Aug. 7, 2008

(54) Approach For Providing Wireless Network Services Using Wireless Access Point Groups

(76) Inventors: Charles Arthur Willman, Austin, TX (US); Nestor Alexis Fesas, Austin, TX (US); Duy Khuong Do, Melbourne (AU); Efstratios Skafidas, Thornbury (AU)

Correspondence Address: HICKMAN PALERMO TRUONG & BECKER, LLP, SUITE 550, 2055 GATEWAY PLACE, SAN JOSE, CA, 95110, US

(21) Appl. No.: 12/026,524

(22) Filed: Feb. 5, 2008

Related U.S. Application Data
(60) Provisional application No. 60/899,751, filed on Feb. 5, 2007.

(51) Int. Cl. H04Q 7/24

(52) U.S. Cl. 370/338

(57) ABSTRACT

An approach for providing wireless network services using a WAP group includes establishing a WAP group that represents a logical grouping of WAPs. Communications between WAPs in the WAP group and clients are performed using a shared BSSID. One of the WAPs in the WAP group is designated as a master WAP and the other WAPs in the WAP group are designated as slave WAPs. The master WAP assigns WAPs in the WAP group to provide wireless networking services to clients. The assignment is performed based upon the performance of communications channels used to carry communications between the clients and the WAPs in the WAP group and current loads of the WAPs in the WAP group. The assignments may be dynamically changed over time, based upon changes in the performance of the communications channels and/or changes in WAP loading.

### RELATED APPLICATION DATA AND CLAIM OF PRIORITY

This application claims the benefit of, and priority to, U.S. Provisional Patent Application No. 60/899,751, entitled Method and Apparatus for Fair Distribution Of Station Loads Among The Access Points In A Managed Wi-Fi Cluster, filed Feb. 5, 2007, the contents of which are incorporated by reference for all purposes as if fully set forth herein.

### FIELD OF THE INVENTION

This invention relates generally to wireless networking.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Wireless Area Networks (WLANs) have grown in popularity because of the availability of low cost equipment and ease of installation and use. It is not uncommon for business organizations to install multiple wireless access points (WAPs) to provide increased coverage and bandwidth. One of the issues with WAP arrangements having multiple WAPs is how to share the load among the WAPs. Clients typically select a particular WAP based upon signal strength, i.e., a client typically connects to a WAP having the strongest detected signal with respect to that client. A client is typically unaware of both how many other clients a particular WAP might be providing services to and the amount of bandwidth that the other clients are consuming. Thus, other than signal strength, it is difficult for a client to know which WAP, from a set of available WAPs, might be best able to provide wireless services to the client. This often results in WAP arrangements having unbalanced loads. Some existing load balancing solutions require that all participants, including WAPs and clients, be sourced from a single vendor.

These issues can be exacerbated for mobile clients that change locations. For example, when a mobile client changes location, it may move within range of other WAPs that may be able to better provide wireless services for the mobile client, even though the client is still within range of the original WAP. For example, the other WAPs may be serving a fewer number of clients or clients that are not using as much bandwidth, compared to the original WAP. Unfortunately, the client is typically not aware of the loading of the other WAPs and therefore continues to use the original WAP, as long as sufficient signal strength exists. Thus, the mobile client is still using the original WAP for wireless services when another WAP may be able to provide better service for the mobile client. Not only does this result in reduced service for the mobile client, but it results in unbalanced loads among WAPs. In view of the foregoing, an approach for providing wireless network services that does not suffer from the limitations of prior approaches is highly desirable.

### BRIEF DESCRIPTION OF THE DRAWINGS

In the figures of the accompanying drawings like reference numerals refer to similar elements.

FIG. 1 is a flow diagram that depicts an approach for providing wireless network services using a WAP group according to one embodiment of the invention.

FIG. 2 is a block diagram of an arrangement for providing wireless network services using a WAP group according to one embodiment of the invention.

FIG. 3 is a block diagram that depicts an example WAP group management data maintained on a storage, according to one embodiment of the invention.

FIG. 4 depicts WAP group just after it has been established and the WAPs in WAP group have not yet been assigned to provide service to any of the clients, according to one embodiment of the invention.

FIG. 5 is a block diagram that depicts a master WAP assigning a particular slave WAP to provide service to a client, according to one embodiment of the invention.

FIG. 6 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:
I. OVERVIEW
II. ARCHITECTURE FOR PROVIDING WIRELESS NETWORK SERVICES USING A WAP GROUP
III. WAP GROUPS
   A. Establishing WAP Groups
   B. Master/Slave WAPs
   C. WAP Group Management Data
IV. INITIAL ASSIGNMENT OF CLIENTS TO WAPs
V. RE-ASSIGNMENT OF CLIENTS FROM WAPs
VI. OTHER FUNCTIONALITY
VII. IMPLEMENTATION MECHANISMS AND EXTENSIONS

### I. OVERVIEW

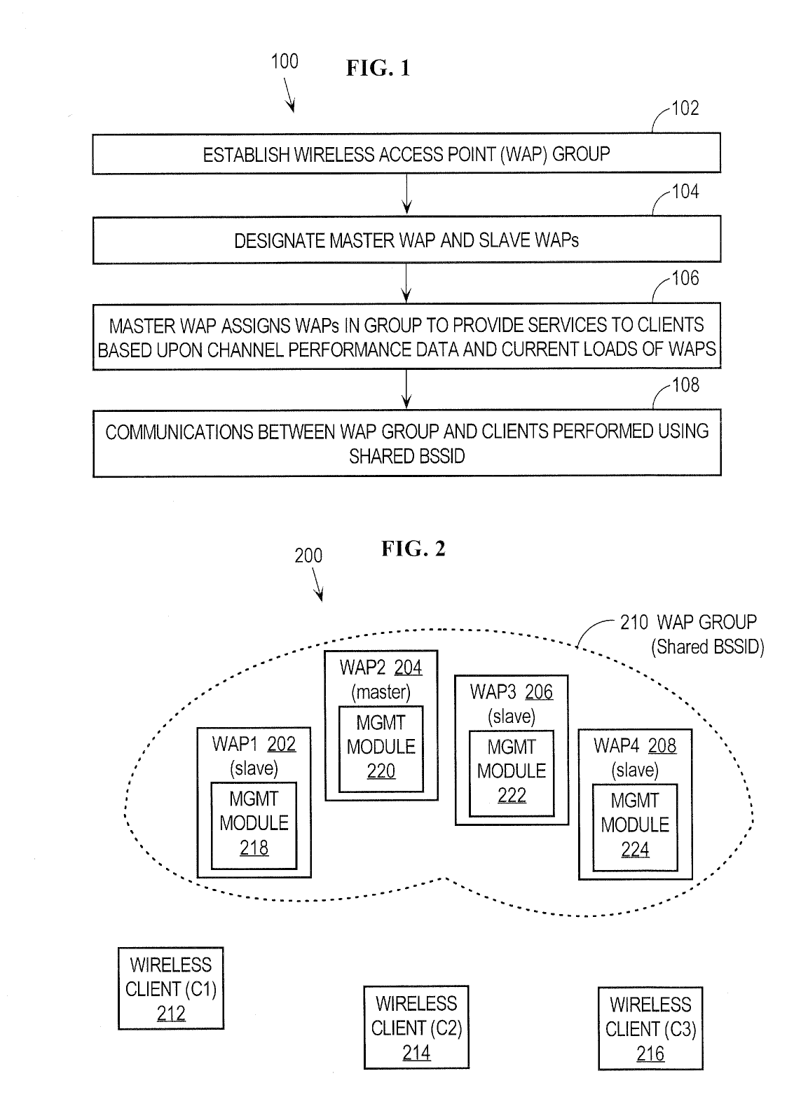

FIG. 1 is a flow diagram 100 that depicts an approach for providing wireless network services using a WAP group, according to one embodiment of the invention. In step 102, a WAP group is established. A WAP group is a logical grouping of WAPs. Communications between WAPs in the WAP group and clients are performed using a shared Basic Service Set Identifier (BSSID), wherein “shared BSSID” means that each of the WAPs in the WAPs group uses the same BSSID. In step 104, one of the WAPs in the WAP group is designated as a master WAP and the other WAPs in the WAP group are designated as slave WAPs. In step 106, the master WAP assigns WAPs in the WAP group to provide wireless networking services to clients. According to one embodiment of the invention, the assignment is performed based upon the performance of communications channels use to carry communications between the clients and the WAPs in the WAP group and current loads of the WAPs in the WAP group. The assignments may be dynamically changed over time, based upon changes in the performance of the communications channels and/or changes in WAP loading. In step 108, communications between the WAP group and client are performed using the shared BSSID.

The approach described herein is very useful in managing the client loads across a set of WAPs and may dynamically adapt to changes in the performance of the communications channels used to carry communications between the clients and the WAPs. This is very helpful in applications that benefit from fair distribution of bandwidth, such as voice over WLAN applications. Furthermore, the approach is very helpful in mobile client applications, particularly for fast roaming, because mobile clients can be transferred to different WAP within a WAP group without having to perform deauthentication/reauthentication, deassociation/reassociation or establish new encryption keys.

### II. ARCHITECTURE FOR PROVIDING WIRELESS NETWORK SERVICES USING A WAP GROUP

FIG. 2 is a block diagram that depicts an arrangement 200 for providing wireless network services using WAP groups, according to one embodiment of the invention. Arrangement 200 includes WAPs 202, 204, 206, 208 (identified in FIG. 2 as WAP1, WAP2, WAP3 and WAP4 respectively) that are logically assigned to a WAP Group 210 that has a shared BSSID. The WAP group 210 provides wireless network services to wireless clients 212, 214, 216 using a shared BSSID, as described in more detail hereinafter. WAPs 202, 204, 206, 208 may be communicatively coupled to one or more wired or wireless networks that provide for communications between WAPs 202, 204, 206, 208. Although WAP group 210 is depicted in the figures and described herein in the context of including four WAPs, a WAP group may include any number of WAPs, depending upon a particular implementation. Also, the approach is applicable to any number of wireless clients.

According to one embodiment of the invention, WAPs 202, 204, 206, 208 are configured with management modules 218, 220, 222, 224, respectively, that provide wireless network services using the WAP group 210, as described hereinafter. The management modules 218, 220, 222, 224 may include the functionality used by master WAPs as well as slave WAPs, or the management modules 218, 220, 222, 224 may be specific to master and slave WAPs. Wireless clients 212, 214, 216, also identified as C1, C2, C3, respectively, may be any type of wireless client. Examples of wireless clients include, without limitation, personal computers, laptop or portable computers, PDAs, telephony devices and mobile devices. Arrangement 200 may include other elements, depending upon a particular implementation, which are not depicted in FIG. 2 or described herein for purposes of brevity.

### III. WAP GROUPS

The approach for providing wireless network services includes using a WAP group. In general, a WAP group is a logical grouping of two or more WAPs. WAPs in the WAP group communicate with wireless clients using a shared BSSID, instead of their own individual BSSIDs. Similarly, wireless clients communicate with the WAP group using the shared BSSID. So, from the perspective of a wireless client, the WAP group is a single WAP.

### A. Establishing WAP Groups

A WAP group may be established manually by an administrator manually configuring WAPs to use the WAP group methodology described herein. Alternatively, WAPs may be configured to automatically use the WAP group methodology. For example, a configuration parameter value may be set in the firmware of a WAP to instruct the WAP to operate in a WAP group mode when the WAP is powered up. The WAPs may use a discovery mechanism to discover other WAPs that are configured to use WAP groups.

### B. Master/Slave WAPs

According to one embodiment of the invention, one WAP in a WAP group is designated as a master WAP and the other WAPs in the WAP group are designated as slave WAPs. The master WAP designates WAPs in the WAP group, including both slave WAPs and the master WAP itself, to provide wireless network services to clients based upon the performance of communications channels use to carry communications between the clients and the WAPs in the WAP group and current loads of the WAPs in the WAP group. The designation of the master WAP may be made using a wide variety of techniques, depending upon a particular implementation. For example, arbitrary assignment, e.g., lowest IP address, or various voting mechanisms may be used. The master WAP should be within range of all other WAPs in the WAP group. A new master WAP may be determined if the current master WAP is not able to perform its management functions. According to one embodiment of the invention, the current master WAP transmits a periodic “heart beat” signal that indicates to the slave WAPs that the master WAP is operating normally. If the slave WAPs do not receive a heart beat signal within a specified time then a new master WAP is designated by, for example, the slave WAPs or by an administrator.

### C. WAP Group Management Data

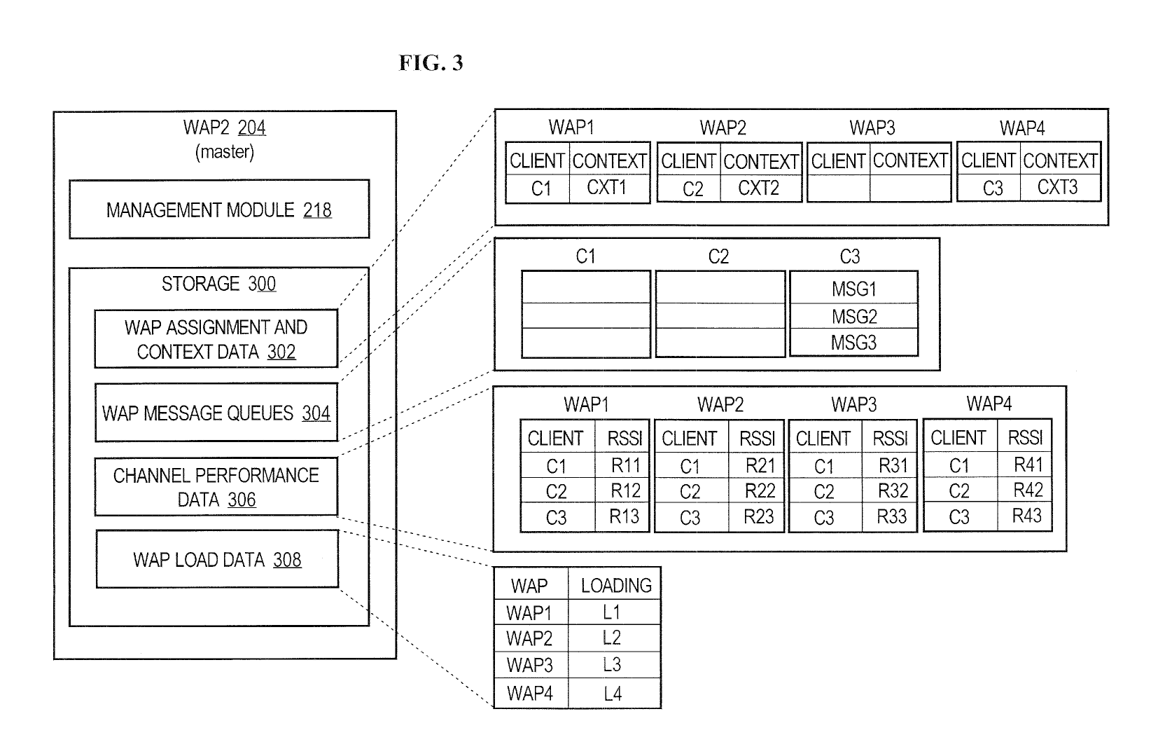

According to one embodiment of the invention, the slave WAP in a WAP group maintains data that is used to manage the WAP group. FIG. 3 is a block diagram that depicts example WAP group management data maintained on storage 300, according to one embodiment of the invention. Storage 300 may be implemented using any type of volatile memory, non-volatile memory, or any combination of volatile and non-volatile memory. Storage 300 includes WAP assignment and context data 302, WAP message queues 304, channel performance data 306 and WAP load data 308. The WAP group management data may include additional data not depicted in FIG. 3 or less data than depicted in FIG. 3, depending upon a particular implementation. Furthermore, although the WAP group management data is depicted in the figures as being stored in tables, the invention is not limited to this context and the WAP group management data may be stored in any type of data structure or format.

The WAP assignment and context data module 302 indicates the client(s) assigned to each WAP in the WAP group 210. In the present example, the WAP assignment and context data 302 reflects an example set of assignments that have already been made, i.e., WAP1 is assigned to service client C1, WAP2 is assigned to service client C2 and WAP4 is assigned to service client C3. WAP3 is not currently assigned to service any clients. The WAP assignment and context data module 302 also includes context data, identified in FIG. 3 as CXT1, CXT2, CXT3, for each assignment. The context data includes, for example, authentication data, association data and security context information, such as encryption keys used with a client. As described hereinafter, the context data may be transferred between WAPs in a WAP group when a client is reassigned from one WAP to another WAP. Context data may also be maintained by WAPs providing service to a client and provided to the master WAP upon request, for example, after the master WAP determines that a change in assignments should be made.

The WAP message queues 304 store messages received by a master WAP from slave WAPs. The master WAP 204 processes the messages stored in the WAP message queues 304 as described in more detail hereinafter.

The channel performance data 306 may include any type of data that indicates the performance of the communications channels used by the WAPs in the WAP groups. For example, the channel performance data 306 may include received signal strength indicator (RSSI) data, bit error rate (BER) data, signal-to-noise ratio (SNR) data, and other types of performance data. In this example, the channel performance data 306 includes RSSI data for each WAP with respect to each client, C1-C3. The RSSI data values contained in channel performance data may represent an average RSSI value over time, or over the last N number of messages received by a slave WAP, or simply the RSSI value from the most recent message received by a slave WAP. The RSSI data may be extracted from messages received by slave WAP1 and WAP3 and supplied to master WAP2, for example in the notification messages. The RSSI data may also be supplied to master WAP2 by another mechanism or entity, depending upon a particular implementation. Although embodiments of the invention are described herein in the context of using RSSI values as channel performance data, the invention is not limited to the use of RSSI values for channel performance data. Other types of channel performance data may be also used. Note that the channel performance data 306 includes channel performance data for the master WAP, WAP2, since the master WAP may also be assigned to service the clients.

WAP load data module 308 indicates the current load of the WAPs in WAP group 210. In the present example, the load values for WAP1-WAP4 are L1-L4, respectively. In one embodiment, the load values may indicate the current number of clients assigned to each WAP. In another embodiment, the load values may indicate loading expressed using other parameters. For example, the load values may indicate an amount of data throughput over time. This may be expressed, for example, by an average number of bytes per minute handled by a slave WAP. As another example, the load values may indicate a packet size distribution. The packet size distribution may indicate an average packet size over time or a category or range of packet sizes over time.

### IV. INITIAL ASSIGNMENT OF CLIENTS TO WAPs

As previously described herein, the master WAP designates WAPs in the WAP group to provide wireless network services to clients based upon the performance of communications channels use to carry communications between the clients and the WAPs in the WAP group and/or current loads of the WAPs in the WAP group. In one embodiment, the WAP group is already operational and an assignment of a particular WAP to a particular client is already established.

In other embodiment, the WAP group is not yet operational. The assignment of WAPs to clients may be performed initially when a WAP group is first created and/or activated to establish an initial assignment of WAPs to clients. The WAP to client assignments may then be reevaluated and updated at any time afterward, as described in more detail hereinafter. WAPs may be assigned to clients on a per-session basis, per-function or operation basis, or per-message basis, depending upon a particular implementation. For example, WAPs may be assigned to handle all wireless access for a particular client or just particular functions or messages.

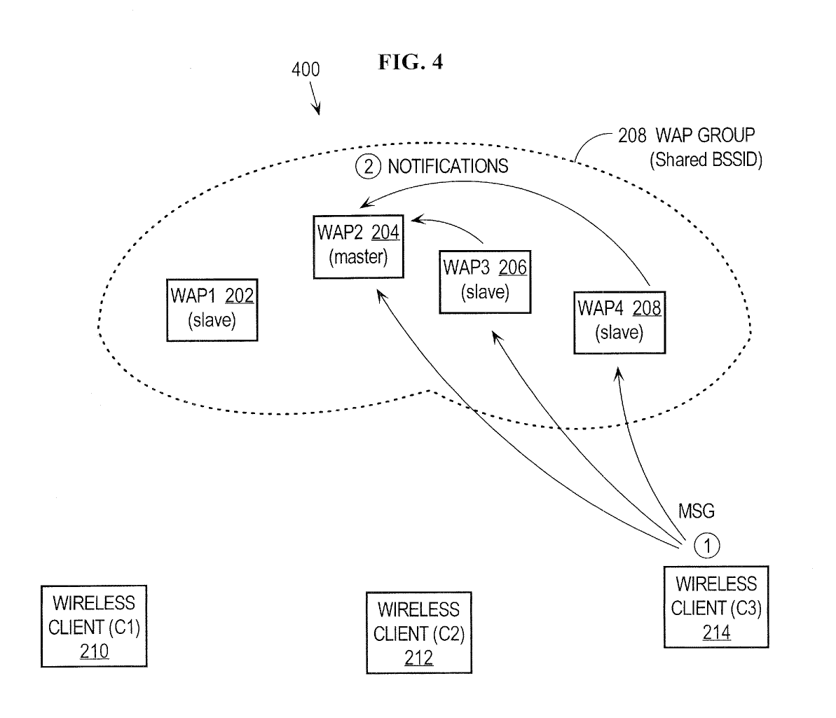

FIG. 4 depicts an arrangement 400 in which WAP group 210 has just been established and the WAPs in WAP group 210 have not yet been assigned to provide service to any of the clients C1-C3. The management modules have been intentionally omitted from FIG. 4 to enhance the reader's understanding of the operation of WAP group 210.

Sometime thereafter, in step 1, wireless client C3 generates and transmits a message. For example, wireless client C3 may generate and transmit a probe request message to search for WAPs that are within range of wireless client C3. In the present example, it is presumed that the message transmitted by client C3 is received by WAP2, WAP3 and WAP4 and not by WAP1, because WAP1 is out of range of client C3. In practice, all the WAPs in a WAP group may be in range of a client, or some of the WAPs in a WAP group may be out of range of a client, depending upon the physical location of the WAPs and clients. In response to the probe request, each WAP that received the probe request sends a probe response to the requesting client.

According to another embodiment, in step 1, wireless client C3 generates and transmits an “association request” to initiate communication with the WAP group. In step 2, each WAP in a WAP group that receives a message from a client, generates and transmits a notification to the master WAP to inform the master WAP that the message has been received. The notification may include any portion(s) of, or all the message received from the client. The notification may be in a wide variety of formats, depending upon a particular implementation. According to one embodiment of the invention, notification and other communications between WAPs in a WAP group conform to the Control and Provisioning of Wireless Access Points (CAPWAP) protocol and are transmitted over a wired network. CAPWAP extensions may be used to provide support for fast connection, event alert, node failure alert and connection teardown and handover. The master WAP 204 stores the notifications from WAP2, WAP3 and WAP 4 in the WAP message queue 304 that corresponds to client C3. In FIG. 3, these messages are represented as messages MSG1, MSG2 and MSG3.

The master WAP 204 processes the notifications from the message queue 304 for client C3 and determines whether a WAP in the WAP group is currently assigned to provide service to the client. According to one embodiment of the invention, the master WAP 204 checks the WAP message queues 304 on a periodic basis to allow time for notifications to be received from all WAPs in the WAP group 210. In the present example, no WAP is currently assigned to provide service to client C3, so master WAP 204 assigns a WAP to client C3 based upon the performance of communications channels used to carry communications between the clients and the WAPs in the WAP group and/or current loads of the WAPs in the WAP group. According to one embodiment of the invention, a WAP in the WAP group having the most favorable communications channel performance with respect to a particular client is assigned to service that client. In the present example, the WAP having the greatest RSSI with respect to a particular client is assigned to service that client. If R33>R13 and R33>R23, then WAP3 is assigned to service client C3. In some situations, a minimum RSSI threshold may also be employed before an assignment is made. For example, only WAPs having at least the minimum RSSI threshold are eligible for assignment.

In situations where both channel performance data and WAP loading are used to make assignments, then the current loading on the candidate WAPs is then used to choose among the candidate WAPs. According to one embodiment of the invention, the candidate WAP having the lowest current load is selected for assignment. An upper bound may also be used on load to select candidate WAPs based upon load. This may avoid assigning a new client to a WAP that is already heavily loaded. For example, WAPs having a current load less than a threshold are candidate WAPs that may be assigned to service a client. The WAP having the lowest current load is then selected from the candidate WAPs.

Once the master WAP assigns a particular WAP to provide service to a client, the master WAP sends a response message to the WAP assigned to provide service to the client. The designated WAP provides service to the client and other WAPs in the WAP group do not respond to requests from that client.

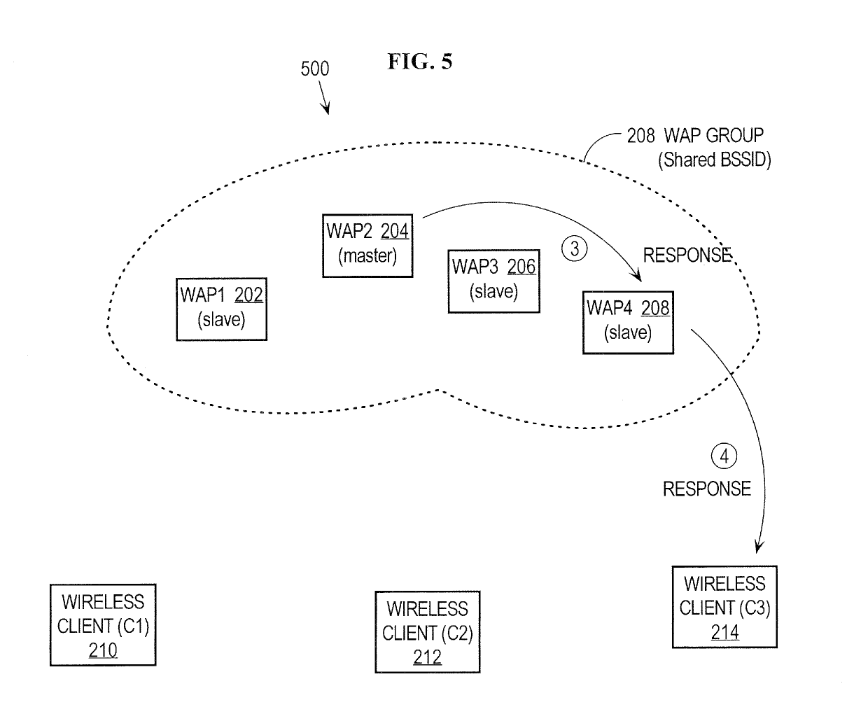

FIG. 5 is a block diagram 500 that depicts a master WAP assigning a particular slave WAP to provide service to a client, according to one embodiment of the invention. As depicted in FIG. 5, in step 3, master WAP 204 generates and transmits a response message to WAP4, instructing WAP4 to provide service to client C3. In response to receiving the response message from the master WAP 204, in step 4, the slave WAP4 generates and transmits a response message to client C3. In the present example, slave WAP4 generates and transmits to client C3 an association response message that includes the shared BSSID for the WAP group 210.

The invention is not limited to the aforementioned approach for initially assigning a WAP from a WAP group to service a client and other approaches may be used. The assigning of a WAP to service a client may be performed at any time. For example, according to one embodiment of the invention, a WAP is assigned to service a client after the master WAP is informed that an association request has been received from a client. In this example, all WAPs respond to client requests, e.g., probe requests and authentication requests, until a particular WAP is assigned to service the client. Once a WAP has been assigned to the client, then only the WAP assigned to provide service responds to requests from the client. In the prior example, WAP2, WAP3 and WAP4 each respond to the probe request and authentication request messages received from client C3, but only WAP4 responds to the association request from client C3. WAP4 also handles all the data messages from client C3 and provides access to a wired network connected to WAP4.

### V. RE-ASSIGNMENT OF CLIENTS FROM WAPs

The performance of communications channels may change over time due to a wide variety of factors. For example, clients may be mobile clients that are moving with respect to a static WAP group, which changes the performance of the communications channels. The performance of a communications channel may decrease as a client moves away from a WAP, while the performance of another communications channel may improve as the client moves closer to another WAP. Noise sources may also be dynamic and may affect the performance of communications channels over time. The current load of WAPs may also change over time. For example, the type and amount of data being provided by a WAP to its assigned clients may change over time, resulting in an increase or decrease in load on that WAP.

According to one embodiment of the invention, WAP assignments may be reevaluated and changed over time to accommodate changes in the performance of communications channels and/or WAP loading. WAP assignments may be reevaluated on a periodic basis or a non-periodic basis, depending upon a particular implementation. The master WAP 204 may be configured to repeat the process described herein for selecting a WAP to service a client. If the selected WAP is different than the currently-assigned WAP, then the assignment may be changed. When an assignment is to be changed for a particular client, the master WAP 204 generates and transmits a message to the WAP currently assigned to the particular client to indicate that the assignment is being changed.

The master WAP 204 may also request current context data from the WAP currently assigned to the particular client. The master WAP 204 also notifies the new WAP to begin servicing the particular client and provides context data to the new WAP. The new WAP may also receive context data directly from the WAP currently assigned to service the particular client. The master WAP 204 also updates the WAP management data stored on storage 300, for example the WAP assignment and context data module 302. Transferring context data between WAPs in the WAP group reduces the amount of time required to change WAPs because context data does not have to be regenerated. Some types of context data, such as security context data including encryption keys, are computationally expensive and time consuming to generate, so allowing a new WAP to use existing context data reduces the amount of time required to change WAP assignments. Also, transferring sequence counters allows security measures to be maintained.

In some situations, a client may choose to disassociate itself from WAPs. This is conventionally performed by a client generating and sending to a WAP a disassociation request. In the context of using WAP groups as described herein, a disassociation request would be “addressed” to the shared BSSID of the WAP group 210. According to one embodiment of the invention, the WAP currently assigned to the client processes the disassociation request and interacts directly with the client to complete the disassociation. The WAP then sends a notification to the master WAP to indicate that the client is no longer being serviced. The master WAP 204 updates the WAP management data to reflect the discontinuation of service.

### VI. OTHER FUNCTIONALITY

In the approach described herein, it is not uncommon for WAPs other than the WAP assigned to service a particular client to also receive communications from the particular client. In the prior example, WAP2, WAP3 and WAP4 are all within range of client C3 and receive communications from client C3. According to one embodiment of the invention, WAPs in a WAP group are configured to report to the master WAP receipts of communications from client, even if those WAPs are not assigned to service those clients. The information may include data that indicates the performance of a communications channel over which the messages were received from the clients. The information may also include data that indicates a current load of WAPs in the WAP group. For example, the information may indicate a current amount of data throughput over time or a packet size distribution. The availability of this information to the master WAP 204 allows the master WAP to make decisions about WAP assignments based upon current channel performance data.

### VII. IMPLEMENTATION MECHANISMS AND EXTENSIONS

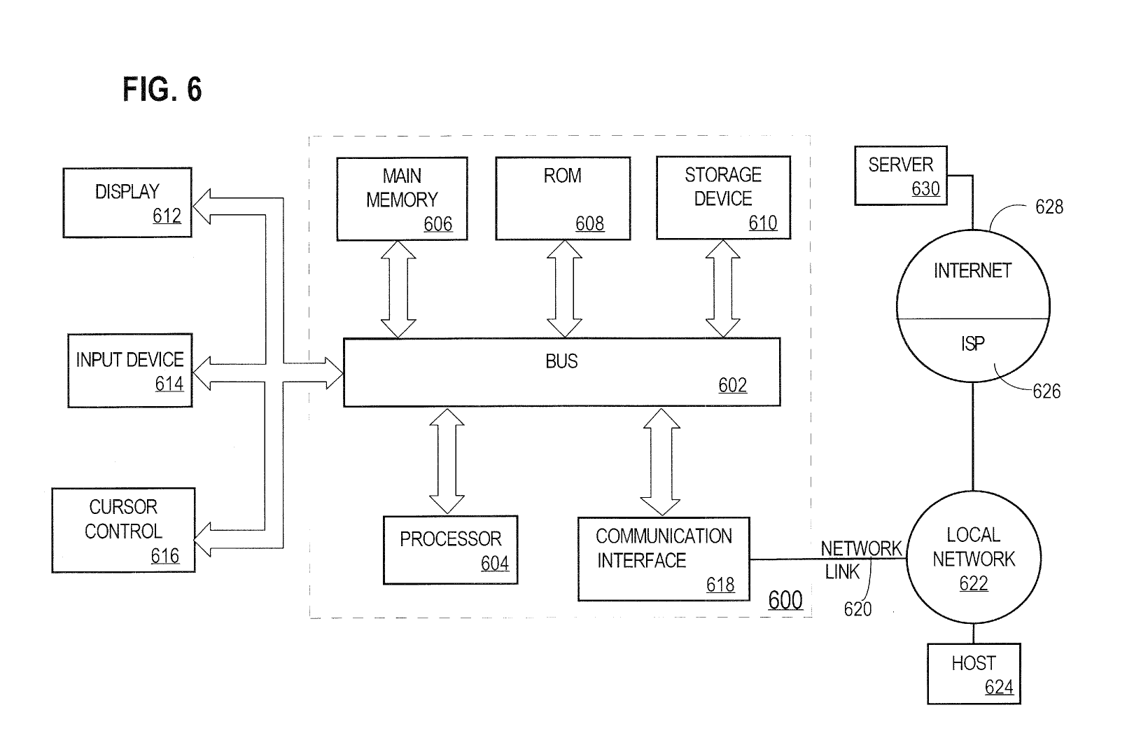

The approach described herein for providing wireless network services using a WAP group may be implemented on any type of computing architecture or computing platform. For purposes of explanation, FIG. 6 is a block diagram that depicts an example computer system 600 upon which embodiments of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 600, various computer-readable media are involved, for example, in providing instructions to processor 604 for execution. Such a medium may take many forms, including but not limited to, non-volatile media and volatile media. Non-volatile media includes, for example, optical or magnetic disks, such as storage device 610. Volatile media includes dynamic memory, such as main memory 606. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for providing wireless communication services, the computer-implemented method comprising:
establishing a wireless access point (WAP) group having at least two wireless access points (WAP), and having a shared Basic Service Set Identifier (BSSID);
designating one of the WAPs in the WAP group as a master WAP;
designating one or more of the other WAPs in the WAP group as slave WAPs, wherein the slave WAPs are each assigned to provide wireless services to one or more clients;
the master WAP selecting a particular slave WAP from the WAP group to provide wireless communication services to a client, wherein the selecting the particular slave WAP is based upon:
performance of communications channels used to carry communications between the client and the WAPs in the WAP group, and
current loads for the WAPs in the WAP group;
the master WAP designating the particular slave WAP to provide wireless communication services to the client; and
wherein communications between clients and the WAPs in the WAP group are performed using the shared BSSID.

2. The method of claim 1, wherein the establishing a WAP group is performed during an installation of a network.

3. The method of claim 1, wherein the establishing a WAP group further comprises one or more of:
adding a WAP to the WAP group; and
removing a WAP from the WAP group.

4. The method of claim 1, wherein designating one of the WAPs in the WAP group as a master WAP further comprises:
identifying a WAP in the WAP group that has a lowest internet protocol address (IP address); and
designating the WAP having the lowest IP address as the master WAP.

5. The method of claim 1, wherein designating one or more of the other WAPs in the WAP group as slave WAPs further comprises designating all WAPs other than the master WAP in the WAP group as slave WAPs.

6. The method of claim 1, wherein communications between the master WAP and the slave WAPs are performed over a wired network.

7. The method of claim 1, wherein communications between the master WAP and the slave WAPs are performed using the Control and Provisioning of Wireless Access Points (CAPWAP) protocol.

8. The method of claim 1, further comprising:
the particular slave WAP receiving a communication message from the client; and
in response to receiving the communication message, the slave WAP generating and transmitting to the master WAP a notification message indicating that the communication message was received.

9. The method of claim 8, wherein the notification message comprises:
client identification data;
client communication context data; and
channel performance data.

10. The method of claim 9, wherein the channel performance data includes a RSSI value.

11. The method of claim 10, wherein the selecting the particular slave WAP based on the performance of communications channels used to carry communications between the client and the WAPs in the WAP group comprises selecting the slave WAP that currently has a largest RSSI value.

12. The method of claim 1, wherein the selecting the particular slave WAP based on the current loads for the WAPs in the WAP group further comprises selecting the slave WAP that currently has a smallest number of assigned clients.

13. The method of claim 1, wherein the master WAP selecting the particular slave WAP from the WAP group to provide wireless communication services to the client further comprises:
selecting the slave WAP that currently has a smallest RSSI value; and
selecting the slave WAP that currently has a smallest number of assigned clients.

14. The method of claim 1, wherein the selecting the particular slave WAP based on the current loads for the WAPs in the WAP group further comprises selecting the slave WAP based upon a packet size distribution.

15. The method of claim 1, wherein the selecting the particular slave WAP based on the current loads for the WAPs in the WAP group further comprises selecting the slave WAP that currently has a smallest data throughput.

16. The method of claim 1, wherein the selecting the particular slave WAP based on the current loads for the WAPs in the WAP group further comprises selecting the slave WAP based upon a capacity of the wireless channel.

17. The method of claim 1, wherein the master WAP designating the particular slave WAP to provide wireless communication services to the client comprises instructing the particular slave WAP to send a communication response message to the client to enable the client to access a network via the particular slave WAP.

18. The method of claim 1, further comprising after the particular slave WAP has been designated, the other slave WAPs in the WAP group not transmitting responses to the client in response to requests from the client.

19. The method of claim 1, further comprising the master WAP generating and maintaining channel performance data that reflects a current performance of the communications channels and WAP load data that reflects a current loading of the WAPs in the WAP group.

20. The method of claim 19, further comprising the master WAP generating and maintaining security context data for the particular slave WAP.

21. The method of claim 19, further comprising the master WAP updating the channel performance data and the WAP load data.

22. The method of claim 1, wherein:
the selecting of the particular slave WAP is made at first time, and
the computer-implemented method further comprises the master WAP selecting and designating another slave WAP from the WAP group to provide wireless communication services to the client, wherein the selecting the another slave WAP is based upon:
performance of the communications channels at a second time that is after the first time, and
current loads for the WAPs in the WAP group at the second time.

23. The method of claim 22, further comprising the master WAP causing security context data associated with the particular slave WAP to be provided to the another slave WAP.

24. The method of claim 1, further comprising in response to receipt of a disassociation request from the client, the master WAP causing the particular slave WAP to be de-designated from the client and the master WAP updating WAP management data to reflect the de-designating of the particular slave WAP from the client.

25. A computer-readable medium for providing wireless communication services, the computer-readable medium carrying instructions which, when executed by one or more processors, cause:
establishing a wireless access point (WAP) group having at least two wireless access points (WAP), and having a shared Basic Service Set Identifier (BSSID);
designating one of the WAPs in the WAP group as a master WAP;
designating one or more of the other WAPs in the WAP group as slave WAPs, wherein the slave WAPs are each assigned to provide wireless services to one or more clients;
the master WAP selecting a particular slave WAP from the WAP group to provide wireless communication services to a client, wherein the selecting the particular slave WAP is based upon:
performance of communications channels used to carry communications between the client and the WAPs in the WAP group, and current loads for the WAPs in the WAP group;
the master WAP designating the particular slave WAP to provide wireless communication services to the client; and
wherein communications between clients and the WAPs in the WAP group are performed using the shared BSSID.

26. An apparatus for providing wireless communication services, the apparatus comprising a memory storing instructions which, when executed by one or more processors, cause:
establishing a wireless access point (WAP) group having at least two wireless access points (WAP), and having a shared Basic Service Set Identifier (BSSID);
designating one of the WAPs in the WAP group as a master WAP;
designating one or more of the other WAPs in the WAP group as slave WAPs, wherein the slave WAPs are each assigned to provide wireless services to one or more clients;
the master WAP selecting a particular slave WAP from the WAP group to provide wireless communication services to a client, wherein the selecting the particular slave WAP is based upon:
performance of communications channels used to carry communications between the client and the WAPs in the WAP group, and
current loads for the WAPs in the WAP group;
the master WAP designating the particular slave WAP to provide wireless communication services to the client; and
wherein communications between clients and the WAPs in the WAP group are performed using the shared BSSID.

27. An apparatus for providing wireless communication services, the apparatus comprising:
means for establishing a wireless access point (WAP) group having at least two wireless access points (WAP), and having a shared Basic Service Set Identifier (BSSID);
means for designating one of the WAPs in the WAP group as a master WAP;
means for designating one or more of the other WAPs in the WAP group as slave WAPs, wherein the slave WAPs are each assigned to provide wireless services to one or more clients;
means for the master WAP selecting a particular slave WAP from the WAP group to provide wireless communication services to a client, wherein the selecting the particular slave WAP is based upon:
performance of communications channels used to carry communications between the client and the WAPs in the WAP group, and
current loads for the WAPs in the WAP group;
means for the master WAP designating the particular slave WAP to provide wireless communication services to the client; and
wherein communications between clients and the WAPs in the WAP group are performed using the shared BSSID.
